(19) United States
(12) Patent Application Publication
(10) Pub. No.: US 2009/0303499 A1
(43) Pub. Date: Dec. 10, 2009

(54) IMAGE FORMING APPARATUS, IMAGE FORMING SYSTEM AND ENLARGEMENT PRINT PROCESSING METHOD OF PRINTING DATA

(75) Inventors: Jae-kyoo KANG, Yongin-si (KR); Young-dal Oh, Suwon-si (KR); Hung-soo Park, Seoul (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/391,533

(22) Filed: Feb. 24, 2009

(30) Foreign Application Priority Data
Jun. 5, 2008 (KR) 2008-53159

(51) Int. Cl. G06K 15/02

(52) U.S. Cl. 358/1.2

(57) ABSTRACT

An enlargement print processing method to enlarge print data and divisionally print the enlarged print data on a plurality of print media, the method including: receiving an enlargement rate to enlarge the print data; determining whether a number of print media, on which the enlarged print data is to be printed, is reducible according to a changed orientation of the plurality of print media; and generating divisional images of the enlarged printing data to have the changed orientation if the number of print media is reducible according to the changed orientation.

### CROSS-REFERENCE TO RELATED APPLICATION

This application claims all benefits accruing under 35 U.S.C. §119 from Korean Patent Application No. 2008-53159, filed on Jun. 5, 2008 in the Korean Intellectual Property Office, the disclosure of which is incorporated herein by reference.

### BACKGROUND OF THE INVENTION

1. Field of the Invention

Aspects of the present invention relate to an image forming apparatus, an image forming system, and an enlargement print processing method of print data, and more particularly to an image forming apparatus having a poster printing mode to print enlarged print data through a plurality of print media divisionally, an image forming system, and an enlargement print processing method of print data.

2. Description of the Related Art

An image forming apparatus receives print data from a host apparatus and prints the print data on a print medium (such as paper, transparencies, etc.). The host apparatus may be a computer, a mobile phone, a personal digital assistant, etc., and the image forming apparatus may be a printer, a facsimile, a multi-function peripheral having two or more functions, etc.

The image forming apparatus is capable of a poster printing mode that enlarges the print data by a predetermined enlargement rate and prints the enlarged print data on a plurality of print media divisionally. FIG. 1 illustrates print data that is enlarged and printed on the plurality of print media divisionally according to a conventional poster printing mode. As shown in FIG. 1, a conventional poster printing mode increases the number of print media in the form of a template of 2×2, 3×3, 4×4, . . . , n×n as the enlargement rate becomes higher. For example, the conventional poster printing mode selects: the template of 2×2 if the enlargement rate is greater than 100% and less than or equal to 200%; the template of 3×3 if the enlargement rate is greater than 200% and less than or equal to 300%; the template of 4×4 if the enlargement rate is greater than 300% and less than or equal to 400%; etc.

However, the number of print media used to print the enlarged print data may be reduced by changing an orientation of the recording medium. For example, where the print medium has a size of A4 and the print data is enlarged at the rate of 140%, the width or the height length of the enlarged print data (i.e., an enlarged image) is smaller than the other length of the print data (i.e., an original image), so that the number of print media can be optimized at a template of 1×2 by changing the orientation of the recording medium (i.e., the enlarged print data can be printed through two sheets of print media). However, when the print data is enlarged at the rate of 140%, the conventional poster printing mode prints the enlarged print data using the template of 2×2 (i.e., on four sheets of print media) divisionally without changing the orientation of the print medium.

Since the conventional poster printing mode does not consider the change in the orientation of the print medium, the print medium may be wasted. Furthermore, as more sheets of print media are used, more time to print the print data is also required. Also, when the print-completed print media are connected, the relatively large number of print media disfigure the enlarged print data divisionally printed thereon, and it is inconvenient for a user to cut and connect the many print media.

### SUMMARY OF THE INVENTION

Accordingly, aspects of the present invention provide an image forming apparatus to optionally change an orientation of a plurality of print media where enlarged print data is divisionally printed in a poster printing mode so as to save printing time and print media, an image forming system, and an enlargement print processing method of printing data.

Aspects of the present invention also provide an image forming apparatus to reduce the number of print media in a poster printing mode so as to decrease a process of cutting and integrating the print media and to enhance an outer appearance of the integrated print media, an image forming system, and an enlargement print processing method of printing data.

Additional aspects and/or advantages of the invention will be set forth in part in the description which follows and, in part, will be obvious from the description, or may be learned by practice of the invention.

In accordance with an example embodiment of the present invention, there is provided an enlargement print processing method to enlarge print data and divisionally print the enlarged print data on a plurality of print media, the method including: receiving an enlargement rate for the print data; determining whether a number of print media, on which the enlarged print data is to be printed, is reducible according to a changed orientation of the plurality of print media; and generating divisional images of the enlarged print data to have the changed orientation if the number of print media is reducible according to the changed orientation.

According to an aspect of the present invention, the determining of whether the number of print media is reducible may include determining that the number of print media is reducible if a width length or a height length of the enlarged print data is less than or equal to an integer times an other length of the print data.

According to an aspect of the present invention, the determining of whether the number of print media is reducible may include determining that the number of print media is reducible if: ((W*scale)≦(H*Nscale)), where, W and H indicate to the width and the height of the print data, respectively (e.g., W<H); scale indicates the enlargement rate; and Nscale indicates the maximum integer less than the enlargement rate.

According to an aspect of the present invention, such a method may further include determining the number of print media to print the enlarged print data when the number of print media is reducible.

According to an aspect of the present invention, the maximum integer less then the enlargement rate may include one of width and height orientations of the print media where the enlarged printing data is to be printed, and the determining of the number of print media where the enlarged print data will be printed may include determining the number of print media in the other orientation.

According to an aspect of the present invention, the determining of the number of print media where the enlarged print data is to be printed includes calculating N according to: ((H* scale)≦(W*(Nscale+N)), where W and H indicate to the width and the height of the print data, respectively (e.g., W<H); scale indicates the enlargement rate; Nscale indicates the maximum integer less than the enlargement rate and the number of print media in the width orientation; and N indicates the number of print media in the height orientation, which is larger than that in the width orientation.

According to an aspect of the present invention, the number of print media may be determined as Nscale×(Nscale+N) that satisfies the expression.

According to an aspect of the present invention, the receiving the enlargement rate for the print data may include receiving the enlargement rate from a user interface.

According to an aspect of the present invention, the enlargement rate may be input by a user or input as one or more preset values.

According to an aspect of the present invention, such a method may further include printing the plurality of generated divisional images.

In accordance with another example embodiment of the present invention, there is provided an image forming apparatus including: an image processing unit to generate divisional images of print data enlarged to be divisionally printed on a plurality of print media; and a controller to determine whether a number of print media is reducible according to a changed orientation of the plurality of print media on which the divisional images are to be printed, and to control the image processing unit to generate the divisional images of the enlarged print data in the changed orientation if the number of print media is reducible according to the changed orientation.

According to an aspect of the present invention, the controller may determine that the number of print media is reducible if a width length or a height length of the enlarged print data is less than or equal to an integer times an other length of the print data.

According to an aspect of the present invention, the controller may determine that the number of print media is reducible if the following expression is satisfied: ((W*scale)≦(H* Nscale)), where W and H indicate the width and the height of the print data, respectively (e.g., W<H); scale indicates the enlargement rate; and Nscale indicates the maximum integer less than the enlargement rate.

According to an aspect of the present invention, the controller may determine the number of print media to print the enlarged printing data when the number of print media is reducible.

According to an aspect of the present invention, the maximum integer less then the enlargement rate may include one of width and height orientations of the print media where the enlarged print data will be printed, and the controller may determine the number of print media in the other orientation to determine the number of print media where the enlarged printing data will be printed.

According to an aspect of the present invention, the controller may calculate N according to: ((H*scale)≦(W*(Nscale+N)), where W and H indicate the width and the height of the print data, respectively (e.g., W<H); scale indicates the enlargement rate; Nscale indicates the maximum integer less than the enlargement rate and the number of print media in the width orientation; and N indicates the number of print media in the height orientation, which is larger than that in the width orientation.

According to an aspect of the present invention, the number of print media may be determined as Nscale×(Nscale+N) that satisfies the expression.

According to an aspect of the present invention, such an image forming apparatus may further include a user interface to receive the enlargement rate for the print data.

According to an aspect of the present invention, the enlargement rate may be input by a user or input as one or more preset values.

According to an aspect of the present invention, such an image forming apparatus may further include a printing unit to print the plurality of generated divisional images.

In accordance with another example embodiment of the present invention, there is provided an image forming system including: a host apparatus that includes an image processing unit to generate divisional images of print data enlarged to be divisionally printed on a plurality of print media, and a controller to determine whether the number of print media is reducible according to a changed orientation of the plurality of print media where the enlarged print data is to be printed, and to control the image processing unit to generate the divisional images of the enlarged print data in the changed orientation where the number of print media is reducible according to the changed orientation; and an image forming apparatus that receives the divisional images from the host apparatus and prints the divisional images on the plurality of print media.

In accordance with yet another example embodiment of the present invention, there is provided an enlargement print processing method to enlarge print data and divisionally print the enlarged print data on a plurality of print media, the method including: receiving an enlargement rate to enlarge the print data; determining an orientation of the plurality of print media, on which the enlarged print data is to be printed, that uses a lowest number of print media as compared to other orientations; and generating divisional images of the enlarged print data to have the determined orientation.

In accordance with still another example embodiment of the present invention, there is provided an image forming apparatus to enlarge print data to be divisionally printed on a plurality of print media, the image forming apparatus including: an image processing unit to generate divisional images of the enlarged print data; and a controller to determine an orientation of the plurality of print media, on which the enlarged print data is to be printed, that uses a lowest number of print media as compared to other orientations, and to control the image processing unit to generate the divisional images of the enlarged print data to have the determined orientation.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 illustrates print data that is enlarged and divisionally printed on a plurality of print media in a conventional poster printing mode;

FIG. 2 is a block diagram of an image forming system according to an example embodiment of the present invention;

FIG. 3 is a block diagram of an image forming apparatus according to another example embodiment of the present invention;

FIGS. 4 through 6 show images divided based to an orientation optionally changed according to an example embodiment of the present invention; and

FIG. 7 is a flowchart of an enlargement print processing method of print data according to an example embodiment of the present invention.

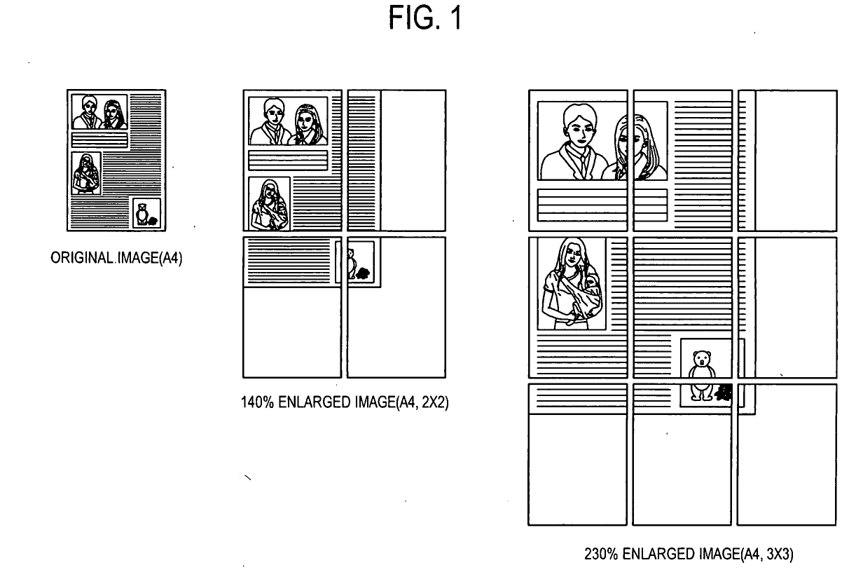

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

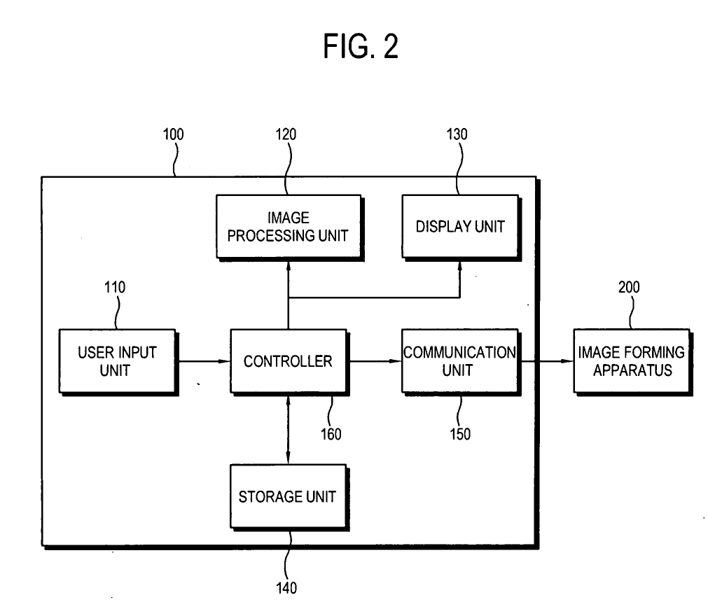

FIG. 2 is a block diagram of an image forming system according to an example embodiment of the present invention. Referring to FIG. 2, the image forming system includes a host apparatus 100 (such as a personal computer (PC), a laptop computer, a mobile phone, a personal digital assistant (PDA), etc.), and an image forming apparatus 200 (such as a printer, a copying machine, a facsimile, a multi-function peripheral having two or more functions, etc.). The image forming system has a poster printing mode in which print data is enlarged at a predetermined enlargement rate and divisionally printed on a plurality of print media.

The host apparatus 100 generates divisional images of the print data enlarged at the enlargement rate, and the image forming apparatus 200 receives the divisional images from the host apparatus 100 and prints the divisional images. The host apparatus 100 includes a user input unit 110, an image processing unit 120, a display unit 130, a storage unit 140, a communication unit 150, and a controller 160.

Alternatively, the image forming apparatus 200 may receive the print data (i.e., an original image) from the host apparatus 100, and generate the divisional images of the print data enlarged at the enlargement rate input through a user interface (UI) provided in the image forming apparatus 200 or transmitted from the host apparatus 100.

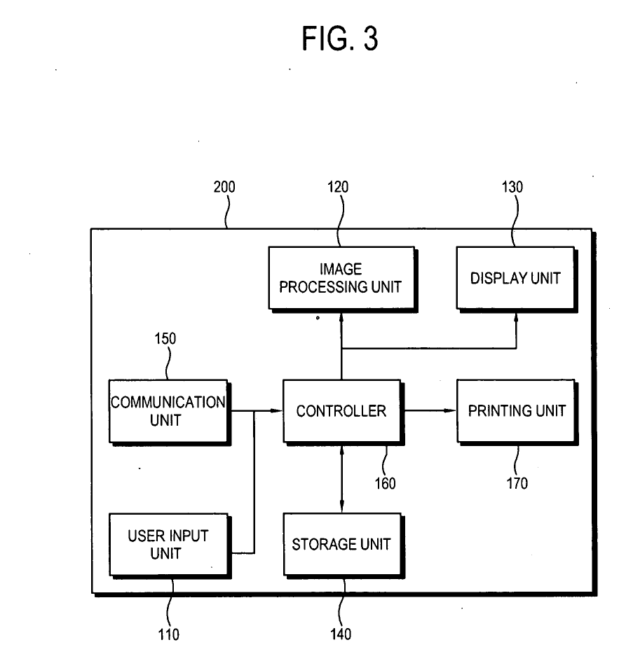

FIG. 3 is a block diagram of an image forming apparatus according to another example embodiment of the present invention. Referring to FIG. 3, the image forming apparatus 200 includes a user input unit 100, an image processing unit 120, a display unit 130, a storage unit 140, a communication unit 150, a controller 160, and a printing unit 170. Throughout the embodiments shown in FIGS. 2 and 3, like numerals refer to like elements, and repetitive descriptions are omitted.

The user input unit 110 receives a user selection of a poster printing mode and receives the enlargement rate for enlarging the print data by a predetermined size. Specifically, when a user selects the poster printing mode for enlarging and divisionally printing the print data on the plurality of print media and inputs a predetermined enlargement rate (%), the controller 160 controls the image processing unit 120 to enlarge an original image of the print data on the basis of a preset enlargement rate and to generate a plurality of divisional images to be printed on the plurality of print media, respectively. It is understood that the enlargement rate may be directly input by a user or input as preset values.

The print data includes a text, an image (or photograph), and/or mixed data where the text and the image are mixed. The divisional images generated in the example embodiment illustrated in FIG. 2 are transmitted to the image forming apparatus 200 through the communication unit 150, and the image processing apparatus 200 receives the divisional images and prints the images on the plurality of recording media, respectively. The user input unit 110 may be one or more key buttons corresponding to operations, a mouse, a keyboard, a touch screen, etc.. Here, when the divisional images of the print data are generated in the image forming apparatus 200 as shown in FIG. 3, the image forming apparatus 200 may be provided with a separate operation key for selecting the poster printing mode. Further, the user input unit 110 may include a user interface (UI) that can be generated by executing a printer driver and displayed on the display unit 130, such that the enlargement rate may be input through the displayed user interface. The image processing unit 120 determines whether the number of print media is reducible according to a change in an orientation of the plurality of print media on which the enlarged printing data is printed, and generates the plurality of divisional images accordingly. Here, the orientation includes a landscape orientation and a portrait orientation.

The display unit 130 displays the print data (i.e., the original image) and the plurality of divisional images to be printed on the plurality of print media. Here, the display unit 130 can display the plurality of divisional images of which orientation is optionally changed in consideration of the enlargement rate.

The storage unit 140 stores the plurality of divisional images of which the orientation is optionally changed in consideration of the enlargement rate. The storage unit 140 may be a volatile memory (such as RAM) or a non-volatile memory (such as ROM, flash memory, or a hard disk drive). Further, the storage unit 140 may store a printer driver, a control program, etc. to control the poster printing mode. For example, the storage unit 140 stores information to determine whether the orientation of the print medium is to be changed based on the input enlargement rate, and stores the enlarged image and the plurality of divisional images according to the changed orientation when the orientation is changed by the selection of a user or in consideration of the preset enlargement rate.

In the example embodiment illustrated in FIG. 2, the communication unit 150 transmits image data corresponding to the plurality of generated divisional images to the image forming apparatus 200. Here, the communication unit 150 may be a wired and/or wireless communication module. The image forming apparatus 200 outputs the plurality of print media on which the plurality of transmitted divisional images are printed.

In the example embodiment illustrated in FIG. 3, the image forming apparatus 200 receives the print data of the original image through the communication unit 150, and generates the plurality of divisional images, for which the orientation is selectively changed according to the enlargement rate, from the received print data. Then, the generated divisional images are printed by the printing unit 170 on the plurality of print media, respectively.

The controller 160 determines whether the number of print media is reducible according to rotation (i.e., a change in an orientation of the plurality of print media on which the print data enlarged by the input enlargement rate is printed), and controls the image processing unit 120 to generate the plurality of divisional images of the enlarged print data to have the orientation where the number of print media is decreased. For example, the controller 160 determines that the number of print media is reducible if the width length or the height length of the enlarged print data is less than or equal to an integer (Nscale) times the other length of the original print data. Here, the Nscale is the maximum integer less than the enlargement rate.

As an example, the controller 160 determines the number of print media where the print data enlarged according to the change in the orientation is reducible if the enlargement rate satisfies the following equation 1 of an orientation-changing condition:

((W*scale)≦(H*Nscale)) [Equation 1]

where W and H respectively refer to the width and the height of an original image (e.g., W<H), scale refers to the enlargement rate, and Nscale refers to the maximum integer less than the enlargement rate.

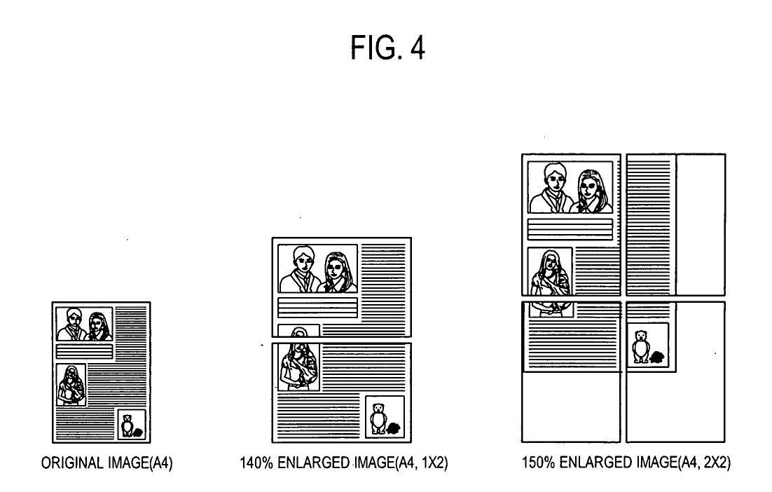

FIGS. 4 through 6 show images divided based on an orientation optionally changed according to an example embodiment of the present invention. Referring to FIG. 4, if an enlargement rate of 140% is applied to a portrait-type original image having a size of A4, the values in the equation 1 are W=21 cm, H=29.7 cm, scale=1.4, and Nscale=1, thereby satisfying the orientation-changing condition. Thus, the controller 160 controls the image processing unit 120 to generate the divisional images corresponding to a landscape-type orientation of the print medium.

In the same manner, if an enlargement rate of 150% is applied to a portrait-type original image having a size of A4, the equation 1 is not satisfied. Thus, the controller 160 controls the image processing unit 120 to generate the divisional images corresponding to the portrait-type orientation of the print medium.

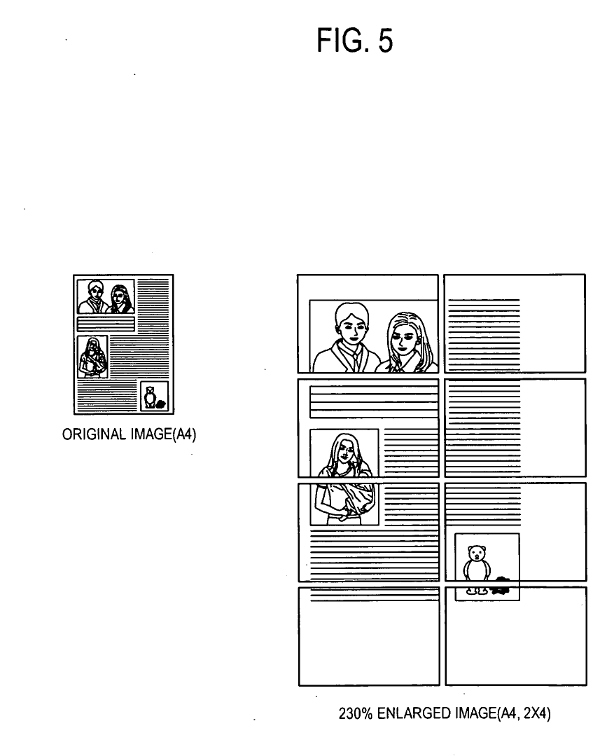

Furthermore, referring to FIG. 5, if an enlargement rate of 230% is applied to a portrait-type original image having a size of A4, the values in the equation 1 are W=21 cm, H=29.7 cm, scale=2.3, and Nscale=2, thereby satisfying the orientation-changing condition. Thus, the controller 160 controls the image processing unit 120 to generate the divisional images corresponding to a landscape-type orientation of the print medium.

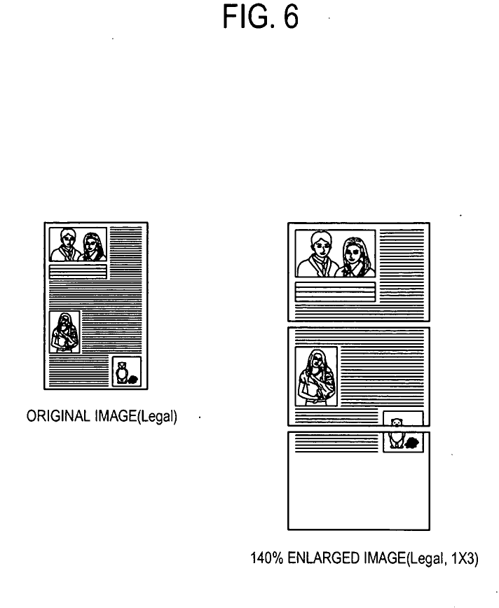

Meanwhile, referring to FIG. 6, if an enlargement rate of 140% is applied to a portrait-type original image having a size of Legal, the values in the equation 1 are W=21.59 cm, H=35.59 cm, scale=1.4, and Nscale=1, thereby satisfying the orientation-changing condition. Thus, the controller 160 controls the image processing unit 120 to generate the divisional images corresponding to a landscape-type orientation of the print medium.

In the case that the input enlargement rate satisfies the orientation-changing condition (i.e., when the number of print media is reducible according to the change in the orientation), the maximum integer less than the enlargement rate (Nscale) refers to the number of print media, on which the enlarged image is printed, in either of the width or height orientation, and the controller 160 may determine the number of pint media in either of the width or height orientation on the basis of the following equation 2.

((H*scale)≦(W*(Nscale+N)) [Equation 2]

where W and H respectively refer to the width and the height of an original image (e.g., W<H), scale refers to the enlargement rate, Nscale refers to the maximum integer less than the enlargement rate and the number of print media in the width orientation, and N refers to the number of print media in the height orientation, which is larger than that in the width orientation.

Specifically, the controller 160 calculates N satisfying the equation 2, and determines the number of print media as Nscale×(Nscale+N). At this time, the controller 160 determines whether the equation 2 is satisfied while sequentially substituting integers from 1 for N in the equation 2, and selects the minimum integer satisfying the equation 2 for N. The number Nscale×(Nscale+N) of print media determined as described above may be the minimum number of print media where the print data is enlarged and divisionally printed.

For example, if an enlargement rate of 140% is applied to a portrait-type original image having a size of A4 and the equation 1 is satisfied, the number Nscale of print media in the width orientation is 1 (Nscale=1). Furthermore, the controller 160 substitutes the values in the equation 2 with W=21 cm, H=29.7 cm and Nscale=1, and sequentially substitutes N with the integers from 1 satisfying the equation 2. Thus, in the case of 140%, N=1. Accordingly, the number of print media on which the original image is enlarged by 140% in the poster printing mode and printed as shown in FIG. 4 is 1×2, so that two sheets of print media are saved as compared with the conventional 2×2.

In the same manner, if an enlargement rate of 230% is applied to a portrait-type original image having a size of A4, the number Nscale of print media in the width orientation is 1 (Nscale=1). Furthermore, the controller 160 substitutes the values in the equation 2 with W=21 cm, H=29.7 cm and Nscale=2, and sequentially substitutes N with the integers from 1 satisfying the equation 2. Here, If N=1, the equation 2 is not satisfied. However, the equation 2 is satisfied if N=2. Thus, in the case of 230%, N=2. Accordingly, the number of print media on which the original image is enlarged by 230% in the poster printing mode and printed as shown in FIG. 5 is 2×4, so that one sheet of print media is saved as compared with the conventional 3×3.

Meanwhile, referring to FIG. 6, if an enlargement rate of 140% is applied to a portrait-type original image having a size of Legal, the number Nscale of print media in the width orientation is 1 (Nscale=1). Further, the controller 160 substitutes the values in the equation 2 with W=21.59 cm, H=35.59 cm and Nscale=1, and sequentially substitutes N with the integers from 1. Here, the equation 2 is satisfied if N=2. Accordingly, in the case where the legal-sized image is enlarged by 140%, the number of print media is 1×3 as shown in FIG. 6, so that one sheet of print media is saved as compared with the conventional 2×2.

Results of applying the foregoing equation 1 and 2 according to the sizes of the recording medium are as follows. In the case of A4 size, if the enlargement rate ranges from 101% to 141%, the number of print media is 1×2 to thereby change the orientation. On the other hand, if the enlargement rate ranges from 142% to 200%, the orientation of the original image is maintained as is. In the case of Letter size, if the enlargement rate ranges from 101% to 129%, the number of print media is 1×2 to thereby change the orientation. On the other hand, if the enlargement rate ranges from 130% to 200%, the orientation of the original image is maintained as is.

In the present embodiments, the equations 1 and 2 are given under the conditions that the original image has a width shorter than the height, and the margin of the print medium and an overlap degree between the plurality of divisional images is 0. Accordingly, the foregoing equations may be adapted according to the landscape or portrait orientation of the original image, the margin of the print medium, and the overlap degree between the divisional images, the size of the print medium, etc.

The controller 160 controls the image processing unit 120 to generate the plurality of divisional images of which an orientation is selectively changed according to the number of print media calculated through the equations 1 and 2.

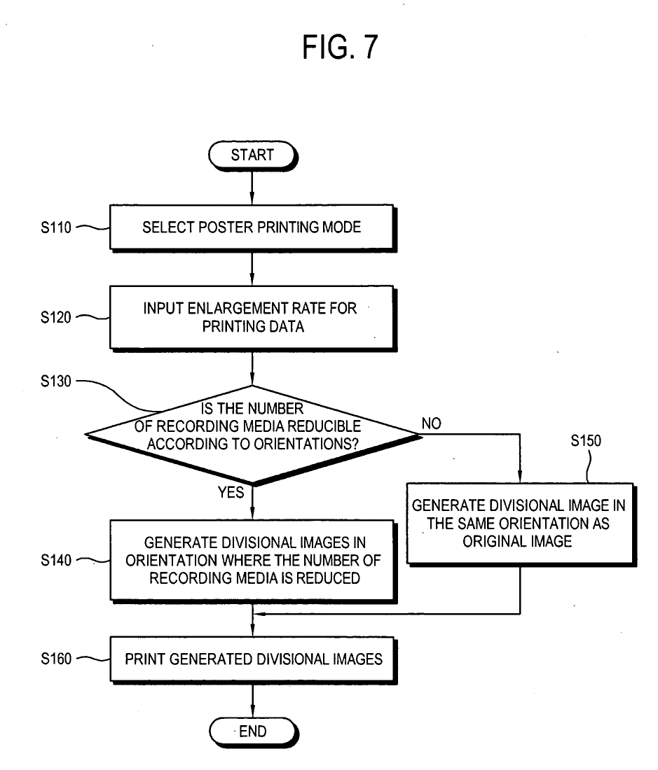

FIG. 7 is a flowchart of an enlargement print processing method of print data according to an example embodiment of the present invention. Referring to FIG. 7, the host apparatus 100 or the image forming apparatus 200 receives a selection from a user for a poster printing mode to print enlarged print data through a plurality of print media divisionally in operation S110.

Then, the controller 160 of the host apparatus 100 or the image forming apparatus 200 receives the enlargement rate (%) to be applied to the print data in the poster printing mode in operation S120. Here, the enlargement rate may be input through a user interface (UI), and the enlargement rate may be directly input by a user or input as preset values. Furthermore, the controller 160 of the host apparatus 100 or the image forming apparatus 200 determines whether the number of print media is reducible according to a change in the orientation of the plurality of print media on which the print data enlarged by the input enlargement rate is to printed in operation S130. For example, if the width or the height length of the enlarged printing data is less than or equal to a maximum integer less than the enlargement rate times the other length of the original image, the controller 160 determines that the number of print media is reducible.

When it is determined that the number of print media is reducible (operation S130), the controller 160 of the host apparatus 100 or the image forming apparatus 200 generates the plurality of divisional images of the print data enlarged to have the orientation such that the number of print media is reduced in operation S140. Here, the operation S140 may include determining the number of print media to be used in the printing. Specifically, in operation S130, the maximum integer less than the enlargement rate refers to how many sheets of print media in the width or height orientations, where the enlarged print data will be printed. Furthermore, in operation S140, the number of print media in the other orientation is determined. Here, the foregoing operations S130 and S140 may be performed by a printer driver, a control program to implement the poster printing mode, etc.

If it is determined that the number of print media is not reducible (operation S130), the controller 160 generates the plurality of divisional images in the same orientation as the print data (i.e., the original image) in operation S150.

Then, the image forming apparatus 200 prints the plurality of generated divisional images on the corresponding print media of which the orientation is optionally changed in operation S160.

As described above, aspects of the present invention provide an image forming apparatus that optionally changes an orientation of a plurality of print media where enlarged print data is divisionally printed in a poster printing mode so as to save printing time and sheets of print media, an image forming system, and an enlargement print processing method of print data. Moreover, according to aspects of the present invention, it is possible to reduce the number of print media in a poster printing mode so as to decrease a process of cutting and connecting the print media and to enhance an outer appearance of the integrated print media.

Aspects of the present invention can also be embodied as computer-readable codes on a computer-readable recording medium. Also, codes and code segments to accomplish the present invention can be easily construed by programmers skilled in the art to which the present invention pertains. The computer-readable recording medium is any data storage device that can store data which can be thereafter read by a computer system or computer code processing apparatus. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present invention may also be realized as a data signal embodied in a carrier wave and comprising a program readable by a computer and transmittable over the Internet.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the enlargement rate may be input as a percentage, a ratio, or a fraction. Furthermore, while the above equations are provided to print the divisional images having the changed orientation in the height orientation, it is understood that the equations can be reversed (i.e., interchanging H and W) to print the divisional images where the original image has a height shorter than the width. Accordingly, it is intended, therefore, that the present invention not be limited to the various example embodiments disclosed, but that the present invention includes all embodiments falling within the scope of the appended claims.

What is claimed is:

1. An enlargement print processing method to enlarge print data and divisionally print the enlarged print data on a plurality of print media, the method comprising:
receiving an enlargement rate to enlarge the print data;
determining whether a number of print media, on which the enlarged print data is to be printed, is reducible according to a changed orientation of the plurality of print media; and
generating divisional images of the enlarged print data to have the changed orientation if the number of print media is reducible according to the changed orientation.

2. The method as claimed in claim 1, wherein:
the determining of whether the number of print media is reducible comprises determining that the number of print media is reducible when a first length of the enlarged printing data is less than or equal to an integer times a second length of the print data before enlarging; and
the first length and the second length are a width and a height, respectively, of the print data or the first length and the second length are the height and the width, respectively, of the print data.

3. The method as claimed in claim 1, wherein the determining of whether the number of print media is reducible comprises determining that the number of print media is reducible when:
((W*scale)≦(H*Nscale)),
where W is a width of the print data before enlarging, H is a height of the print data before enlarging, scale is the enlargement rate, and Nscale is a maximum integer less than the enlargement rate.

4. The method as claimed in claim 3, further comprising determining the number of print media to print the enlarged print data when the number of print media is reducible.

5. The method as claimed in claim 4, wherein:
the maximum integer less then the enlargement rate is the number of print media, on which the enlarged print data is to be printed, in a width orientation of the print media; and
the determining of the number of print media to print the enlarged print data comprises determining a number of print media in a height orientation.

6. The method as claimed in claim 5, wherein the determining of the number of print media to print the enlarged print data comprises calculating N according to:
((H*scale)≦(W*(Nscale+N)),
where W is the width of the print data before printing, H is the height of the print data before printing, scale is the enlargement rate, Nscale is the maximum integer less than the enlargement rate and the number of print media in the width orientation, and N is the number of print media in the height orientation, which is larger than the number of print media in the width orientation.

7. The method as claimed in claim 6, wherein the number of print media is determined as Nscale×(Nscale+N).

8. The method as claimed in claim 1, wherein the receiving of the enlargement rate to enlarge the print data comprises receiving the enlargement rate from a user interface.

9. The method as claimed in claim 1, wherein the enlargement rate is input by a user or input as one or more preset values.

10. The method as claimed in claim 1, further comprising printing the generated divisional images on the print media.

11. The method as claimed in claim 1, wherein the determining of whether the number of print media is reducible comprises determining that the number of print media is reducible when:
((H*scale)≦(W*Nscale)),
where W is a width of the print data before enlarging, H is a height of the print data before enlarging, scale is the enlargement rate, and Nscale is a maximum integer less than the enlargement rate.

12. The method as claimed in claim 11, further comprising determining the number of print media to print the enlarged print data in a width orientation when the number of print media is reducible according to:
((W*scale)≦(H*(Nscale+N)),
where W is the width of the print data before printing, H is the height of the print data before printing, scale is the enlargement rate, Nscale is the maximum integer less than the enlargement rate and the number of print media in a height orientation, and N is the number of print media in the width orientation, which is larger than the number of print media in a height orientation.

13. The method as claimed in claim 1, wherein the receiving of the enlargement rate to enlarge the print data comprises receiving a selection of a poster printing mode.

14. The method as claimed in claim 1, further comprising transmitting the generated divisional images to an image forming apparatus to print the generated divisional images on the plurality of print media.

15. An image forming apparatus to enlarge print data to be divisionally printed on a plurality of print media, the image forming apparatus comprising:
an image processing unit to generate divisional images of the enlarged print data; and
a controller to determine whether a number of print media, on which the enlarged print data is to be printed, is reducible according to a changed orientation of the plurality of print media, and to control the image processing unit to generate the divisional images of the enlarged print data to have the changed orientation if the number of print media is reducible according to the changed orientation.

16. The image forming apparatus as claimed in claim 15, wherein:
the controller determines that the number of print media is reducible when a first length of the enlarged print data is less than or equal to an integer times a second length of the print data before enlarging; and
the first length and the second length are a width and a height, respectively, of the print data or the first length and the second length are the height and the width, respectively, of the print data.

17. The image forming apparatus as claimed in claim 15, wherein the controller determines that the number of print media is reducible when:
((W*scale)≦(H*Nscale)),
where W is a width of the print data before enlarging, H is a height of the print data before enlarging, scale is the enlargement rate, and Nscale is a maximum integer less than the enlargement rate.

18. The image forming apparatus as claimed in claim 17, wherein the controller determines the number of print media to print the enlarged print data when the number of print media is reducible.

19. The image forming apparatus as claimed in claim 18, wherein:
the maximum integer less then the enlargement rate is the number of print media, on which the enlarged print data is to be printed, in a width orientation of the print media; and
the controller determines the number of print media, in the height orientation, to print the enlarged print data.

20. The image forming apparatus as claimed in claim 19, wherein the controller calculates N according to:
((H*scale)≦(W*(Nscale+N)),
where W is the width of the print data before printing, H is the height of the print data before printing, scale is the enlargement rate, Nscale is the maximum integer less than the enlargement rate and the number of print media in the width orientation, and N is the number of print media in the height orientation, which is larger than the number of print media in the width orientation.

21. The image forming apparatus as claimed in claim 20, wherein the controller determines the number of print media as Nscale×(Nscale+N).

22. The image forming apparatus as claimed in claim 15, further comprising a user interface to receive the enlargement rate for the print data.

23. The image forming apparatus as claimed in claim 15, wherein the enlargement rate is input by a user or input as one or more preset values.

24. An image forming system to enlarge print data to be divisionally printed on a plurality of print media, the image forming system comprising:
a host apparatus to process the print data, the host apparatus comprising:
an image processing unit to generate divisional images of the enlarged print data, and
a controller to determine whether a number of print media, on which the enlarged print data is to be printed, is reducible according to a changed orientation of the plurality of print media, and to control the image processing unit to generate the divisional images of the enlarged printing data to have the changed orientation if the number of recording media is reducible according to the changed orientation; and
an image forming apparatus that receives the generated divisional images from the host apparatus and prints the generated divisional images on the plurality of print media.

25. The image forming system as claimed in claim 24, wherein:
the controller determines that the number of print media is reducible when a first length of the enlarged printing data is less than or equal to an integer times a second length of the print data before enlarging; and
the first length and the second length are a width and a height, respectively, of the print data or the first length and the second length are the height and the width, respectively, of the print data.
